(19) United States
(12) Patent Application Publication
(10) Pub. No.: US 2009/0111570 A1
(43) Pub. Date: Apr. 30, 2009

(54) Gaming Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/261,323

(22) Filed: Oct. 30, 2008

(30) Foreign Application Priority Data
Oct. 31, 2007 (JP) 2007-283441

(51) Int. Cl. A63F 9/24; A63F 13/00

(52) U.S. Cl. 463/20

(57) ABSTRACT

When a slot machine accepts a bet of a gaming value, the slot machine renews each bonus payout data based on the bet gaming values. The slot machine drawn a bonus payout indicated in the renewed bonus payout data on each bonus symbol corresponding to bonus payout. The slot machine scroll-displays and repositions symbols on a variable display portion by using a reel band including the bonus symbol on which the bonus payout is drawn. When a bonus condition based on the bonus symbol is satisfied on the variable display portion, the slot machine pays out a bonus payout amount corresponding to the bonus condition.

### CROSS-REFERENCE TO RELATED APPLICATIONS

This application is based upon and claims a priority from the prior Japanese Patent Application No. 2007-283441 filed on Oct. 31, 2007, the entire contents of which are incorporated herein by reference.

### BACKGROUND

1. Field

The present invention relates to a gaming machine that repositions symbols on a display after the symbols are scroll-displayed. In particular, the present invention relates to a gaming machine that awards a progressive payout amount as a prize under a predetermined condition.

2. Description of Related Art

As a conventional game machine, there has been known a gaming machine which scroll-displays a plurality of symbols and then repositions the symbols on a display, and awards a prize depending on a condition of the repositioned symbols. In such gaming machines, some gaming machine which awards a progressive payout amount when a predetermined condition is satisfied is known (for example, a gaming machine described in the specification of U.S. Pat. No. 6,923,718).

The progressive payout amount is sequentially accumulated under a predetermined condition. Accordingly, the progressive payout amount will be a higher payout amount. Therefore, a player who executes a game on a gaming machine is eager to recognize the current progressive payout amount.

In this point, in the specification of U.S. Pat. No. 6,923,718, the gaming machine has a display device which displays a image related to the progressive payout amount on an upper portion of the gaming machine. Therefore, the player can recognize the progressive payout amount by visually seeking the display device.

In the gaming machine described in the specification of U.S. Pat. No. 6,923,718, information related to a progressive payout amount is displayed on a display device arranged on the upper portion of a main body of the gaming machine. Therefore, when a player checks the progressive payout amount, the player must look up to the display device to visually check display contents of the display device. At this time, the player must look aside from a display on which the game is being executed. That is, the gaming machine described in the specification of U.S. Pat. No. 6,923,718 forces a player to bear the burden when the player checks the progressive payout amount. Furthermore, during a game, the line of sight of the player moves between the display on which the game is being executed and the display device. Therefore, the gaming machine deteriorates the interest in the gaming machine.

The present invention relates to a gaming machine that scroll-displays and repositions symbols and awards a progressive payout amount as a prize under a predetermined condition. In particular, it is an object of the present invention to provide a gaming machine which reduces a load on a player with respect to checking of a progressive payout amount and which can prevent an interest in a game from being deteriorated.

### SUMMARY

Therefore, in order to achieve the object, according to a first aspect of the present invention, there is provided a gaming machine comprising: a display which arranges and displays a plurality of symbols including at least one special symbol on which a progressive payout amount is drawn; and a processor which executes: (a) a process of accepting a bet of a gaming value; (b) a process of extracting image data indicating a progressive payout amount from a memory for illustrating the progressive payout amount on the special symbol after an acceptance of the bet is completed; (c) a process of over-illustrating the progressive payout amount extracted from the memory on the special symbol and scroll-displaying a symbol column including the plurality of symbols on the display; (d) a process of repositioning the plurality of symbols on the display by stopping scroll of the symbol column which is scroll-displayed on the display; and (e) a process of, when a combination of symbols repositioned on the display is a special combination including the special symbol defined for obtaining a progressive payout, paying out the progressive payout amount drawn on the special symbol.

When a combination of symbols repositioned on a display has an arrangement of a special combination including a special symbol, this gaming machine pays out a progressive payout amount associated with the special symbol.

In this case, on the special symbol with which payout of the progressive payout amount is associated, the progressive payout amount is drawn. Therefore, when the scroll is stopped to reposition the special symbol on the display, the player can recognize the progressive payout amount by visually seeking the special symbol. As a result, the gaming machine can reduce a load on the player with respect to recognition of the progressive payout amount. The player need not move his/her line of sight from the display on which the game is being executed. Therefore, the gaming machine can prevent an interest in the gaming machine from being deteriorated by moving of the line of sight.

The gaming machine reads out the image data representing the progressive payout amount from a memory, and draws the image data read over the special symbol. Accordingly, the gaming machine can appropriately provide information related to the progressive payout amount to a player.

According to one or more aspects of the present invention, there is provided a gaming machine comprising: a display which arranges and displays a plurality of symbols including a special symbol on which a progressive payout amount is drawn; and a processor which executes: (a) a process of accepting a bet of a gaming value; (b) a process of adding a part of a betted gaming value to the progressive payout amount stored in the memory and renewing information indicating the progressive payout amount; (c) a process of extracting the progressive payout amount renewed from the memory and over-illustrating the progressive payout amount renewed on the special symbol; (d) a process of scroll-displaying a symbol column including the plurality of symbols on the display; (e) a process of repositioning the plurality of symbols on the display by stopping scroll of the symbol column which is scroll-displayed on the display; and (f) a process of, when a combination of symbols repositioned on the display is a special combination including the special symbol defined for obtaining a progressive payout, paying out the progressive payout amount drawn on the special symbol.

When a combination of symbols repositioned on a display has an arrangement of a special combination including the special symbol, this gaming machine pays out the progressive payout amount associated with the special symbol.

In this case, the progressive payout amount is drawn as the special symbol. Therefore, the player can recognize the progressive payout amount by visually seeking the special symbol. As a result, the gaming machine can reduce a load on the player with respect to the recognition of the progressive payout amount. The player need not move his/her line of slight from the display on which the game is being executed. Accordingly, the gaming machine can prevent an interest in the gaming machine from being deteriorated by movement of the line of sight.

When a gaming value is bet, the bet gaming value is partially added to the progressive payout amount. The gaming machine renews information related to the progressive payout amount. In this regard, the gaming machine reads out image data representing the renewed progressive payout amount from the memory, and draws the image data read over the special symbol. As a result, the gaming machine can provide information related to the latest renewed progressive payout amount to a player.

According to one or more aspects of the present invention, there is provided a gaming machine comprising: a display which arranges and displays a plurality of symbols including plural types of special symbols on each of which a progressive payout amount is drawn; and a processor which executes: (a) a process of accepting a bet of a gaming value; (b) a process of adding a part of a betted gaming value to each of a plural progressive payout amounts stored in the memory, each corresponding to respective one of the plural types of special symbols, and renewing information indicating each of the plurality of progressive payout amounts; (c) a process of extracting from the memory each of the plural progressive payout amounts renewed, and drawing a picture of each of the plural progressive payout amounts extracted over respective special symbols corresponding thereto; (d) a process of scroll-displaying a symbol column including the plurality of symbols on the display; (e) a process of repositioning the plurality of symbols on the display by stopping scroll of the symbol column which is scroll-displayed on the display; and (f) a process of, when a combination of symbols repositioned on the display is a special combination including any one of the plural types of special symbols which is defined for obtaining a progressive payout, paying out a progressive payout amount drawn on the one of the plural types of special symbols which is repositioned.

The gaming machine scroll-displays a plurality of symbols including plural types of special symbols. And, the gaming machine awards a prize corresponding to a combination of the symbols repositioned on a display to a player. Each of plural types of special symbols is associated with respective one progressive payout amount of a plurality of progressive payout amounts stored in the memory when a special combination including a special symbol of any one of the types is repositioned on the display, the gaming machine pays out a progressive payout amount drawn on the repositioned special symbol.

In this case, a progressive payout amount corresponding to the type of the special symbol is drawn on each of the special symbols. Consequently, when a special combination is repositioned, the player can recognize a progressive payout amount to be paid out easily by visually seeking the special symbols constituting the special combination. When the repositioned symbols include each of the special symbols, the player can recognize a plurality of progressive payout amounts without receiving the progressive payout amount. In this manner, when the plurality of progressive payout amounts can be paid out, the gaming machine can reduce a load on the player required to recognize each of the progressive payout amounts. The player need not move a line of sight from the display on which the game is being executed. Therefore, the gaming machine can prevent an interest in the gaming machine from being deteriorated by the movement of the line of sight.

In the gaming machine, when a gaming value is bet, the bet gaming value is partially added to each of the plurality of progressive payout amounts. The gaming machine renews information related to each of the progressive payout amounts. In this regard, the gaming machine reads out image data representing each of the renewed progressive payout amounts from the memory, and draws the image data read each of the special symbols. Therefore, the gaming machine can provide the latest renewed information to the player with respect to plural types of progressive payout amounts.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is an explanatory view with respect to the renewal of the bonus payout amount drawn on bonus symbols;

FIG. 2 is a perspective view of a slot machine;

FIG. 3 is an explanatory view illustrating reel display portions of the slot machine;

FIG. 4 is an explanatory view illustrating symbol display portion of the slot machine;

FIG. 5 is a block diagram illustrating an internal constitution of the slot machine;

FIG. 6 is a block diagram illustrating an internal constitution of the sub control board of the slot machine;

FIG. 7 is an explanatory view illustrating normal symbols constituting each reel of the slot machine;

FIG. 8 is an explanatory view illustrating a symbol column constituting each reel;

FIG. 9 is an explanatory view illustrating bonus symbols constituting each reel;

FIG. 10 is an explanatory view with respect to three kinds of progressive jackpot;

FIG. 11 is an explanatory view illustrating a variable display portion upon variable display of reel bands;

FIG. 12 is an explanatory view illustrating a variable display portion upon stop and display of symbols;

FIG. 13 is an explanatory view illustrating a payout table of the slot machine;

FIG. 14 is a flow chart of a main control process program;

FIG. 15 is a flow chart of a main game process program;

FIG. 16 is an explanatory view illustrating a table associating code numbers and symbols;

FIG. 17 is an explanatory view illustrating a table associating random number values and code numbers;

FIG. 18 is a flow chart of a bonus symbol display renewal process program; and

FIG. 19 is an explanatory view with respect to a bonus symbol composite process.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

An embodiment in which a gaming machine according to the present invention is applied to a slot machine 1 will be described below with reference to the accompanying drawings. The slot machine according to the embodiment includes an image display device such as a liquid crystal display. The slot machine displays images of various symbols on the image display device to perform a game. That is, the slot machine is a so-called video slot machine.

When three or more bonus symbols 50 of a specific type (i.e., any one type of a mega bonus symbol 51 through a mini bonus symbol 53) are stopped on a variable display portion 3B (S18: YES), the slot machine 1 according to the embodiment awards a progressive jackpot corresponding to the type of the bonus symbols 50 (S19).

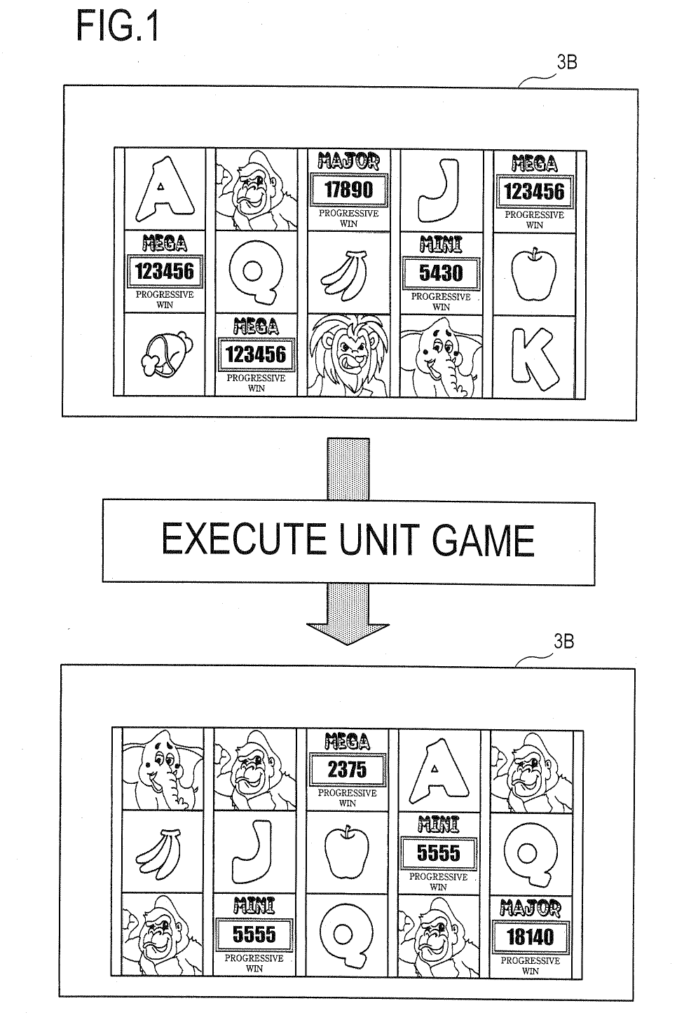

Each of the bonus symbols 50 (i.e., the mega bonus symbol 51 through the mini bonus symbol 53) according to the embodiment includes a bonus payout notification area 50B respectively. Bonus payouts based on a jackpot corresponding to the type of the bonus symbol 50 (i.e., any payout amount of “MEGA JACKPOT”, “MAJOR JACKPOT”, and “MINI JACKPOT” (will be described later)) is drawn in the bonus payout notification area 50B. Thus, when the bonus symbols 50 is stopped on the variable display portion 3B, the player can recognize the contents of a bonus payout based on the jackpot on the basis of the bonus payout notification area 50B of the bonus symbols 50 (refer to FIG. 1).

Since the jackpot is a progressive jackpot, each bonus payout according to the embodiment varies depending on betting of a gaming value by a player or payout of a bonus payout. In this regard, the slot machine 1 overwrites a bonus payout at the present on the bonus payout notification area 50B that is, the slot machine 1 renews the latest bonus payout as needed (refer to FIG. 1). Therefore, the slot machine 1 can cope with a variation in bonus payout. More specifically, the slot machine 1 can notify the player of information related the latest bonus payout desired by the player.

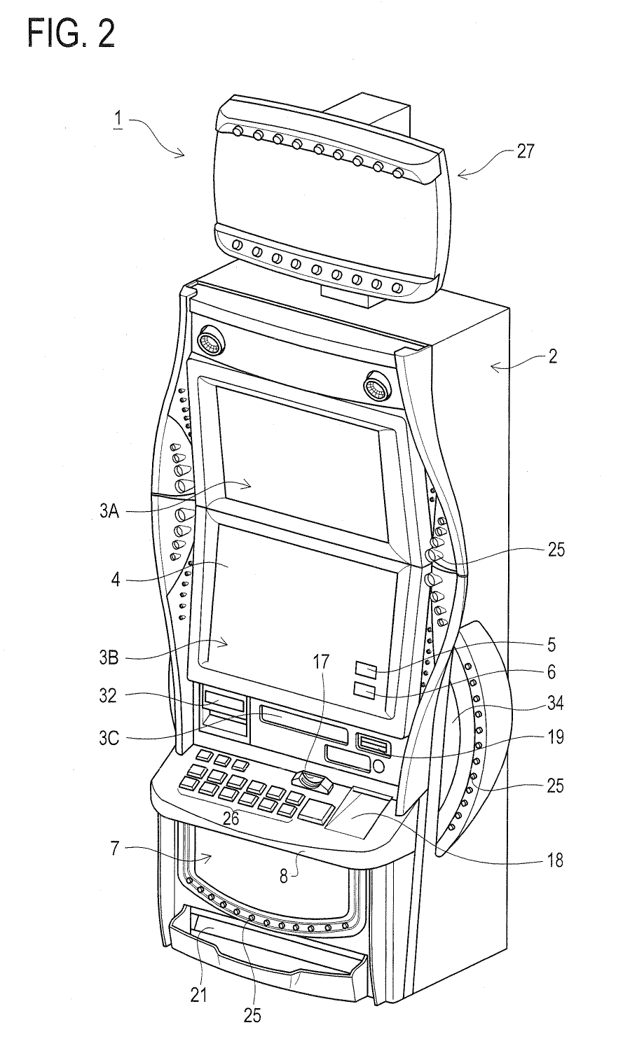

A schematic configuration of the slot machine 1 according to the embodiment will be described below in detail with reference to the accompanying drawings. FIG. 2 is an external perspective view of the slot machine 1 according to the embodiment.

The slot machine 1 according to the embodiment is an upright slot machine installed in a game arcade such as a casino. An appearance of the slot machine 1 shown in FIG. 2 is merely an example in the present invention. The slot machine 1 is not limited to the appearance thereof.

As shown in FIG. 2, the slot machine 1 has a cabinet 2. The cabinet 2 is a storage unit for storing an electric or mechanical component to execute a predetermined game mode.

The slot machine 1 includes an upper display portion 3A, a variable display portion 3B, and a lower display portion 3C on the front of the cabinet 2. The upper display portion 3A, the variable display portion 3B, and the lower display portion 3C display various kinds of gaming information.

The upper display portion 3A is constituted of a liquid crystal panel. The upper display portion 3A is arranged on an upper portion of the cabinet 2. The upper display portion 3A displays an effect image, a payout table in a game, a game rule, and the like.

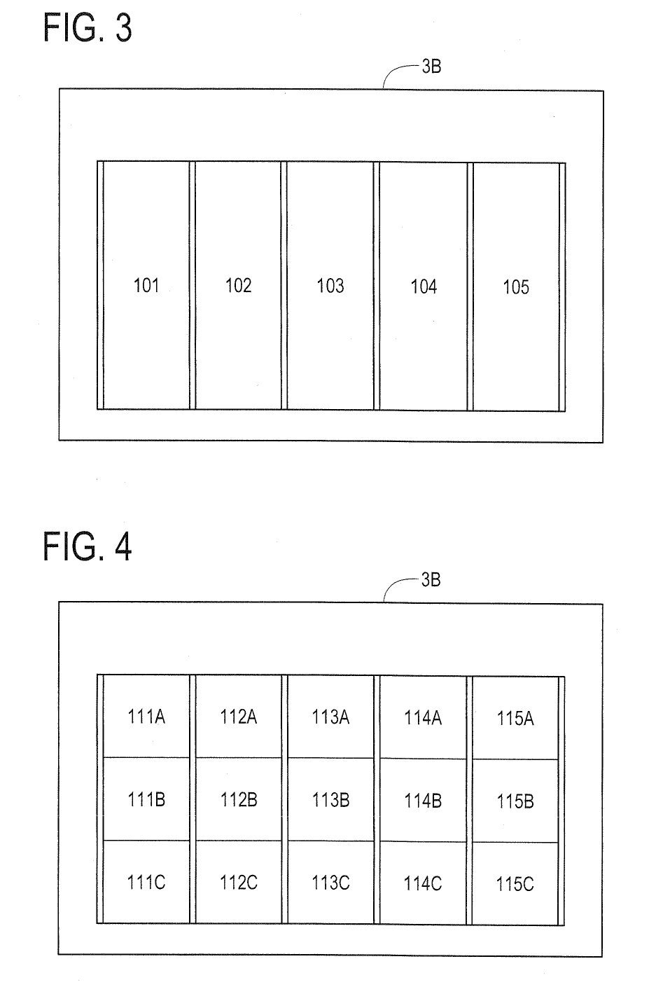

The variable display portion 3B is constituted of a liquid crystal panel. The variable display portion 3B is arranged on the middle portion of the cabinet 2. The variable display portion 3B has five reel display portions 101 through 105 (refer to FIG. 3). A symbol column is variably displayed and stop-displayed on each of the reel display portions. Each of the reel display portions 101 through 105 has three symbol display areas. More specifically, the reel display portions 101 through 105 have symbol display areas 111A through 111C, symbol display areas 112A through 112C, symbol display areas 113A through 113C, symbol display areas 114A through 114C, and symbol display areas 115A through 115C, respectively. The symbol display areas each display one symbol (refer to FIG. 4). More specifically, the variable display portion 3B displays fifteen symbols in a 3×5 matrix. The number of reels and the number of display symbols on one reel display portion are variable.

A touch panel 4 is arranged in front of the liquid crystal panel of the variable display portion 3B. A player can input various commands by operating the touch panel 4. The payout amount display portion 5 and the credit amount display portion 6 are arranged on a lower right portion of the variable display portion 3B. In this regard, the display positions of the payout amount display portion 5 and the credit amount display portion 6 are arbitrarily determined. A bet amount display portion for displaying a bet amount can also be arranged on the variable display portion 3B. The payout amount display portion 5 displays a payout amount awarded to the player (i.e., a payout amount awarded when a predetermined condition is satisfied in a normal game). The credit amount display portion 6 displays a credit amount that the player currently possesses.

The lower display portion 3C is constituted a liquid crystal panel. The lower display portion 3C is arranged on the lower portion of the cabinet 2. The lower display portion 3C displays a point recorded on a card and a point of a game. When a card is not inserted, or the reading of a card is failed, the lower display portion 3C displays the fact that the card is not inserted or the reading of the card is failed.

Furthermore, the card reading portion 19 is arranged around the lower display portion 3C. The card reading portion 19 reads information stored in a card that the player currently possesses.

As described above, in the embodiment, the upper display portion 3A, the variable display portion 3B, and the lower display portion 3C are constituted of liquid crystal displays, respectively. However, the present invention is not limited to the configuration. For example, the display portions may be configured by using CRT displays, plasma displays, LED displays, and other known display devices.

A lower panel 7 is arranged on a lower portion of the lower display portion 3C. The lower panel 7 is composed of a plastic panel on which a picture of a character related to the slot machine 1 or the name of the slot machine 1 is drawn. The lower panel 7 is illuminated by a backlight. The lower panel 7 may also be composed of a liquid crystal display, a CRT display, a plasma display, an LED display, or another known display device.

An operation table 8 is arranged on a lower portion of the variable display portion 3B. Various operation buttons 26 (an exchange button, a payout button, a help button, a BET button, a start button and the like) are arranged on the operation table 8. A coin insertion portion 17 and a bill insertion portion 18 are also arranged on the operation table 8.

The position to arrange the respective types of operation buttons can be determined arbitrarily. As necessary, one portion of the respective operation buttons may be eliminated or buttons may be newly added or replaced.

A coin payout portion and a coin tray 21 are formed in a lower portion of the cabinet 2. The coin payout portion serves to payout coins when the exchange button or the payout button is operated.

The coin tray 21 serves to receive coins that were paid out from the coin payout portion. A coin detecting portion is arranged in the coin payout portion. The coin detecting portion is composed of a sensor and the like. The coin detecting portion detects the number of coins paid out from the coin payout portion.

Furthermore, a light emitting portion 25 is arranged around the cabinet 2 of the slot machine 1. When a player wins a prize or plays a free game, the light emitting portion 25 lights in a predetermined lighting style. Furthermore, a speaker 34 for audio output is arranged on a side surface of the cabinet 2. The light emitting portion 25 and the speaker 34 are arranged at arbitrary positions, respectively.

As shown in FIG. 2, the slot machine 1 includes a topper effect device 27 on an upper portion of the cabinet 2. The topper effect device 27 has a rectangular board shape. The topper effect device 27 is arranged in substantially parallel to the upper display portion 3A. The topper effect device 27 displays various kinds of information. The shape of the topper effect device 27 can be designed an arbitrarily.

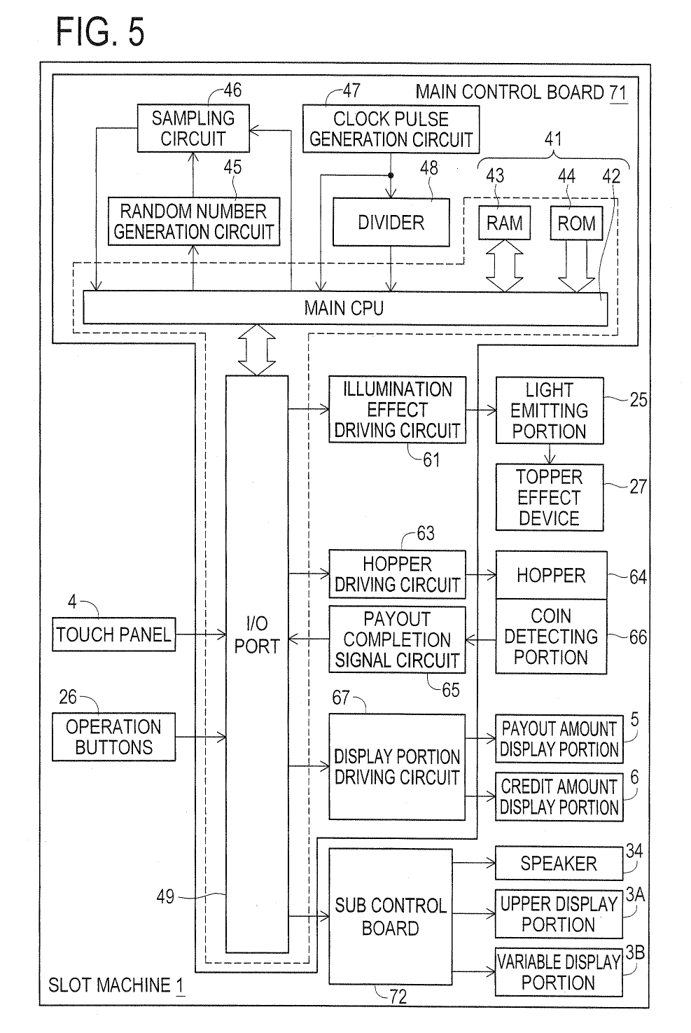

Next, an internal configuration of the slot machine 1 will be described below with reference to the accompanying drawings. FIG. 5 is a block diagram showing the internal configuration of the entire slot machine 1. As shown in FIG. 5, the slot machine 1 has a main control board 71 including a controller 41, as a functional core. The slot machine 1 has a plurality of components. The main control board 71 has the controller 41, a random number generation circuit 45, a sampling circuit 46, a clock pulse generation circuit 47, a divider 48, an illumination effect driving circuit 61, a hopper driving circuit 63, a payout completion signal circuit 65, and a display portion driving circuit 67.

The controller 41 has a main CPU 42, a RAM 43, and a ROM 44. The main CPU 42 operates according to a program stored in the ROM 44 and executes the input and output of signals with other components through an I/O port 49. More specifically, the main CPU 42 controls the operation of the entire slot machine 1. The RAM 43 stores data and programs that are used during the operation of the main CPU 42.

For example, the RAM 43 temporarily stores a random number value sampled by the sampling circuit 46 after the game is started. The RAM 43 stores code numbers corresponding to the reel display portions 101 through 105. The ROM 44 stores various control programs which are executed by the main CPU 42 and permanent data.

The RAM 43 stores mega bonus payout data, major bonus payout data, and mini bonus payout data. The mega bonus payout data indicates a bonus payout according to “MEGA JACKPOT” (will be described later). The major bonus payout data indicates a bonus payout according to “MAJOR JACKPOT”. The mini bonus payout data indicates a bonus payout according to “MINI JACKPOT”.

When a gaming value of a player is bet, the bonus payout data of the three types are renewed to indicate a value obtained by accumulating a predetermined percentage (refer to FIG. 10) of the bet gaming value (S13). When a predetermined bonus condition is satisfied, and a bonus payout amount is paid out, the bonus payout data is initialized. More specifically, the bonus payout data is renewed to regulated initial values shown in FIG. 10 (S19). A cumulative storing method in a gaming machine using a plurality of jackpots can be set as needed.

The program stored in the ROM 44 includes a game program and a game system program (to be referred to as a game program hereinafter). Furthermore, the game program includes a lottery program.

The lottery program is executed when determining a code number corresponding to a symbol stopped at a middle portion of the reel display portions 101 through 105 of the variable display portion 3B (i.e., symbol display areas 111B, 112B, 113B, 114B, and 115B).

The lottery program includes symbol weighting data. The symbol weighting data shows a corresponding relationships between the respective code numbers and one or more random number values within a predetermined numerical value range (for example, 0 through 25). The probability of lottery with respect to each symbol on the reel band is set by associating one or a plurality of random number values to one code number. The random number values are drawn by lottery and symbols which are identified as final from the random number values are displayed in a predetermined area on the variable display portion 3B.

The random number generation circuit 45 is operated according to a command from the main CPU 42, and thus generates a random numbers in a predetermined range. The sampling circuit 46 extracts arbitrary random numbers from the random numbers generated by the random number generation circuit 45 according to the command from the main CPU 42. The sampling circuit 46 inputs the extracted random number to the main CPU 42. The clock pulse generation circuit 47 generates a reference clock that is used to operate the main CPU 42. The divider 48 inputs the signals, which are obtained by dividing the reference clock at a predetermined length of cycle, to the main CPU 42.

Furthermore, the touch panel 4 is connected to the main control board 71. As described above, the touch panel 4 is arranged in front of the variable display portion 3B the touch panel 4 identifies a coordinate position of a portion touched by a player. As a consequence, the touch panel 4 can judge an operation of the player (for example, a specific place touched by a player or a direction in which the touched place moves) based on the information of coordinate position that is identified. A signal depending on the judgment is input to the main CPU 42 through the I/O port 49.

The operation button 26 (the start button described above or the like), which are used to command the executing of a game, is connected to the main control board 71 through the operation switch. Therefore, a signal in accordance with a depressing operation of operation button 26 is input to the main CPU 42 through the I/O port 49.

The illumination effect driving circuit 61 executes an illumination effect on the light emitting portion 25 and the topper effect device 27 by outputting an effect signal according to the command from the main CPU 42. The topper effect device 27 is connected to the illumination effect driving circuit 61 through the light emitting portion 25.

The hopper driving circuit 63 drives a hopper 64 according to control of the main CPU 42. In this manner, the hopper 64 executes a predetermined operation, and pays out coins to the coin payout portion. The coin detecting portion 24 counts the number of the coins paid out by the hopper 64. The coin detecting portion 24 inputs coin amount data showing the amount of coins that was detected to the payout completion signal circuit 65. The payout completion signal circuit 65 receives the coin amount data from the coin detecting portion 24. When the received coin amount data reaches the set coin amount value, the payout completion signal circuit 65 inputs to the main CPU 42 a signal which notifies completion of coin payout. The display portion driving circuit 67 controls display operations of respective display portions including the payout amount display portion 5 and the credit amount display portion 6 and the like.

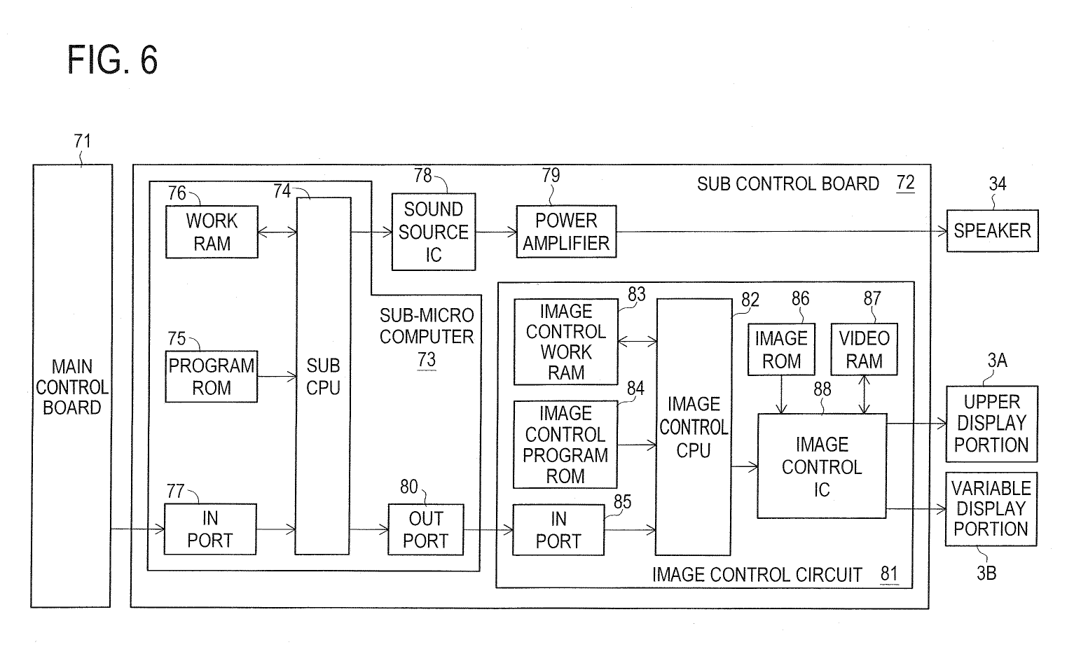

Furthermore, a sub control board 72 is connected to the main control board 71. As shown in FIG. 6, the sub control board 72 controls the display of each display portions and the audio output from the speaker 34 on the basis of a command input from the main control board 71. The sub control board 72 is arranged on a circuit board different from the circuit board configuring the main control board 71. The sub control board 72 has a microcomputer (to be referred to as a “sub-micro computer 73” hereinafter) as a main component. The sub control board 72 has a sound source IC 78, a power amplifier 79, and an image control circuit 81. The sound source IC 78 controls audio output from the speaker 34. The power amplifier 79 functions as an amplifier that amplifies the audio output from the speaker 34. The image control circuit 81 functions as a display control device for the upper display portion 3A and the variable display portion 3B.

The sub-micro computer 73 has a sub CPU 74, a program ROM 75, a work RAM 76, and I/O ports 77 and 80. The sub CPU 74 executes a control operation according to a control command transmitted from the main control board 71. The program ROM 75 stores a control program that are executed in the sub CPU 74. The work RAM 76 is composed of a temporary memory when the control programs are executed in the sub CPU 74.

The sub control board 72 does not include a clock pulse generation circuit, a divider, a random number generator, and a sampling circuit. In this regard, the sub control board 72 executes random number sampling on an operation program of the sub CPU 74.

The image control circuit 81 has an image control CPU 82, an image control work RAM 83, an image control program ROM 84, an image ROM 86, a video RAM 87, and an image control IC 88. The image control CPU 82 determines images to be displayed on the upper display portion 3A and the variable display portion 3B based on the parameters set by the sub-micro computer 73 and an image control program (will be described later). For example, the image control CPU 82 displays a payout table and a help screen on the upper display portion 3A. The image control CPU 82 variably displays and stops symbols in the symbol display areas 111A through 111C, 112A through 112C, 113A through 113C, 114A through 114C, and 115A through 115C.

Furthermore, the image control CPU 82 generates bonus payout images 50C (i.e., a mega bonus payout image 51C through a mini bonus payout image 53C) corresponding to bonus payout data stored in the RAM 43 on the basis of the respective bonus payout data (S23). The image control CPU 82 synthesizes the generated bonus payout images 50C with bonus symbol base images 50A (that is, mega bonus symbol base images 51A through mini bonus symbol base images 53A) corresponding to the bonus payout images 50C, respectively. In this manner, the image control CPU 82 generates the bonus symbols 50 (i.e., the mega bonus symbol 51 through the mini bonus symbol 53).

The image control program ROM 84 stores an image control program related to displays on the upper display portion 3A and the variable display portion 3B and various selection tables. The image control work RAM 83 functions as a temporary memory when the image control program is executed by the image control CPU 82.

The image control IC 88 forms images that correspond to the contents determined by the image control CPU 82. The image control IC 88 outputs the formed image to the upper display portion 3A and the variable display portion 3B. The image ROM 86 stores dot data that is used to form images. Image data used in S23 and S24 (will be described later) are stored in the image ROM 86. The video RAM 87 functions as a temporary memory used when images are formed by the image control IC 88.

The internal configuration of the slot machine 1 described above is a mere example and is not limited to the above configuration. For example, a memory card or a PLD (Programmable Logic Device) can also be attached to or detached from the slot machine 1. In this case, the slot machine 1 may also be configured to read necessary information from the memory card or the PLD.

In the slot machine 1 according to the present invention, a coin, a bill, or electronic valuable information (credit) corresponding thereto is used as a gaming value. However, the game value, which can be applied to the present invention, is not limited thereto. For example, the slot machine may be formed to be capable of using medals, tokens, electronic money, and tickets.

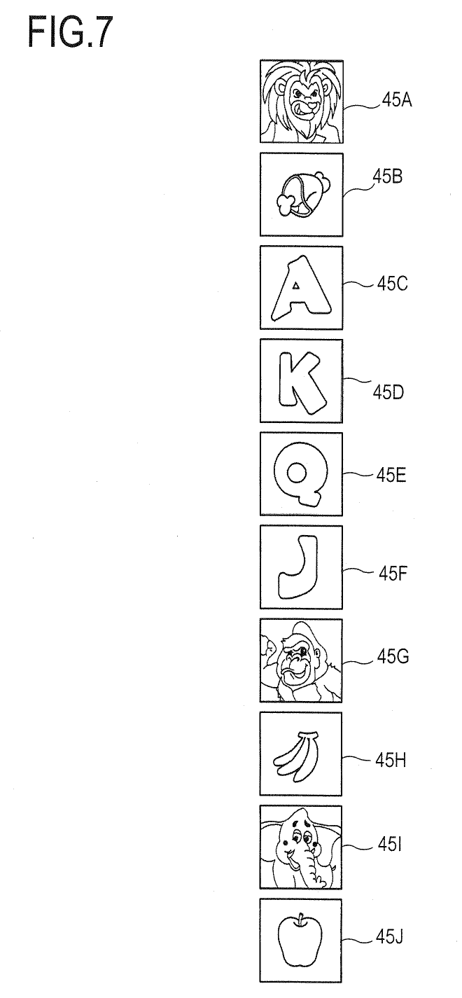

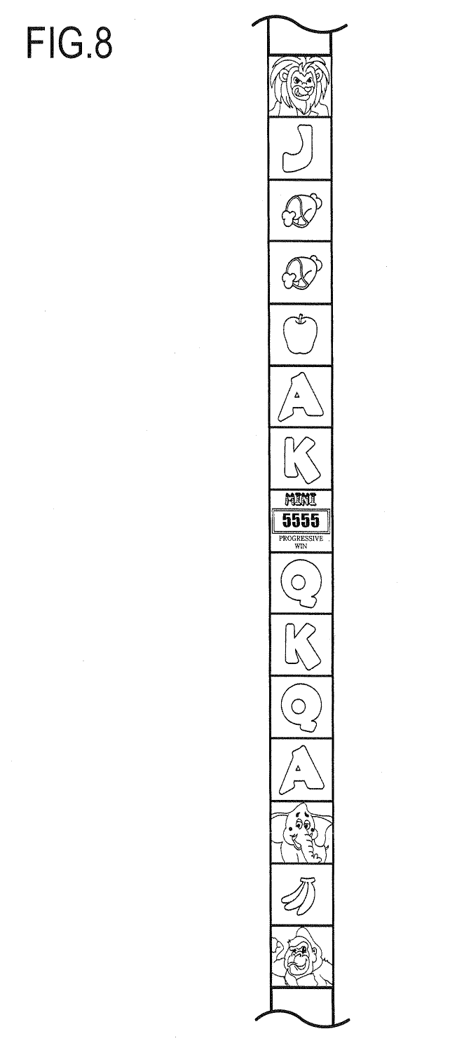

Subsequently, symbols drawn on a reel band variably displayed on the reel display portion will be described below in detail with reference to the accompanying drawings. FIG. 7 is a view showing an example of symbols drawn on the reel bands variably displayed on the reel display portions 101 through 105. FIG. 8 shows a reel band (external reel) variably displayed on each of the reel display portions.

As shown in FIGS. 7 and 8, the reel band in the embodiment includes eleven types of normal symbols. The eleven types of the normal symbols include a lion symbol 45A (LION), a meat symbol 45B (MEAT), an ace symbol 45C (A), a king symbol 45D (K), a queen symbol 45E (Q), a jack symbol 45F (J), a gorilla symbol 45G (GORILLA), a banana symbol 45H (BANANA), an elephant symbol 45I (ELEPHANT), and an apple symbol 45J (APPLE).

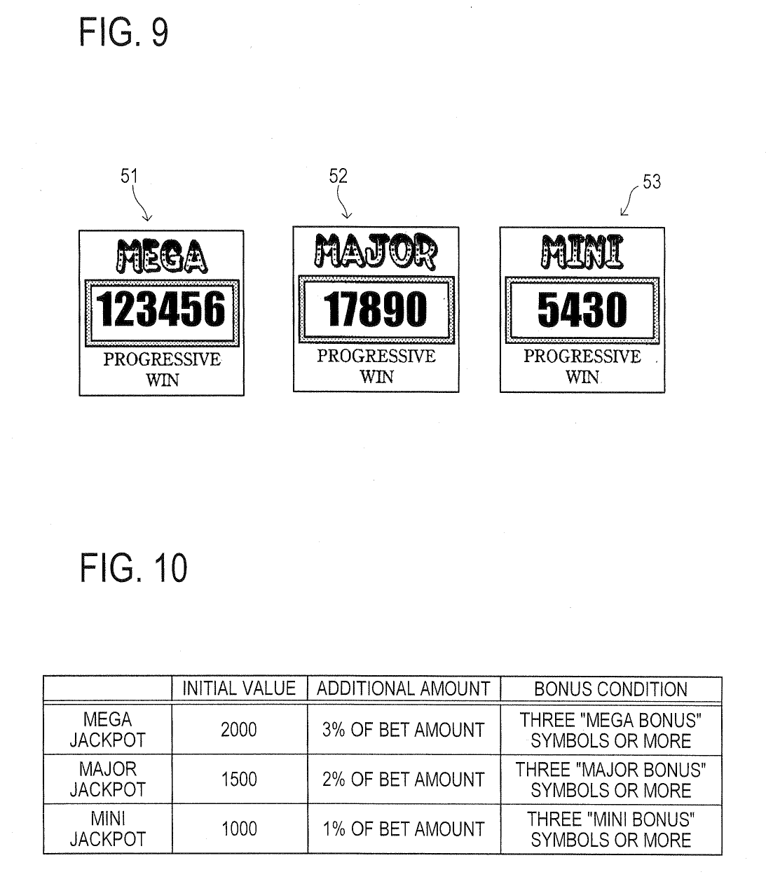

The reel band according to the embodiment can include three types of the bonus symbols 50 in addition to the eleven types of the normal symbols. The three types of the bonus symbols 50 include the mega bonus symbol 51, the major bonus symbol 52, and the mini bonus symbol 53 (refer to FIG. 9).

Therefore, as shown in FIG. 8, the eleven types of the normal symbols and the three types of the bonus symbols 50 are drawn on the reel band in a predetermined order. In this regard, the reel band shown in FIG. 8 is a mere example. The order in which the symbols are drawn may also be determined arbitrarily. The number of symbols drawn on one reel band is determined arbitrarily, and types of to-be-drawn symbols may also be defined arbitrarily.

Here, the three types of the bonus symbols 50 included in the reel band and bonus payouts will be described below. As described above, in the embodiment, the mega bonus symbol 51, the major bonus symbol 52, and the mini bonus symbol 53 are present.

As shown in FIG. 10, the mega bonus symbol 51 is a symbol which configures a bonus condition to receive a bonus payout based on a progressive jackpot related to “MEGA JACKPOT”. More specifically, the bonus condition of the progressive jackpot related to “MEGA JACKPOT” is satisfied when the three or more mega bonus symbols 51 are stopped on the variable display portion 3B.

In the bonus payout related to “MEGA JACKPOT”, when a player bets a gaming value, 3% of the bet gaming value (to be referred to as a bet amount) is added to a present bonus payout (refer to FIG. 10). An initial value of the bonus payout related to “MEGA JACKPOT” is “2000 credits” (refer to FIG. 10). Therefore, when the slot machine 1 is powered on, or when the bonus payout amount related to “MEGA JACKPOT” is paid out, the bonus payout amount related to “MEGA JACKPOT” is “2000 credits” which is the initial value.

The major bonus symbol 52 is a symbol which configures a bonus condition to receive a bonus payout based on a progressive jackpot related to “MAJOR JACKPOT”. More specifically, in the slot machine 1, a bonus condition of the progressive jackpot related to “MAJOR JACKPOT” is satisfied when three or more major bonus symbols 52 are stopped on the variable display portion 3B.

In the bonus payout related to “MAJOR JACKPOT”, when a player bets a gaming value, 2% of the amount is added to a present bonus payout (refer to FIG. 10). An initial value of the bonus payout related to “MAJOR JACKPOT” is “1500 credits” (refer to FIG. 10). Therefore, when the slot machine 1 is powered on, or when the bonus payout amount related to “MAJOR JACKPOT” is paid out, the bonus payout amount related to “MAJOR JACKPOT” is “1500 credits” which is the initial value.

The mini bonus symbol 53 is a symbol which configures a bonus condition to receive a bonus payout based on a progressive jackpot related to “MINI JACKPOT”. More specifically, in the slot machine 1, a bonus condition of the progressive jackpot related to “MINI JACKPOT” is satisfied when three or more mini bonus symbols 53 are stopped on the variable display portion 3B.

In the bonus payout related to “MINI JACKPOT”, when a player bets a gaming value, 1% of the bet amount is added to a present bonus payout (refer to FIG. 10). An initial value of the bonus payout related to “MINI JACKPOT” is “1000 credits” (refer to FIG. 10). Therefore, when the slot machine 1 is powered on, or when the bonus payout amount related to “MINI JACKPOT” is paid out, the bonus payout amount related to “MINI JACKPOT” is “1000 credits” which is the initial value.

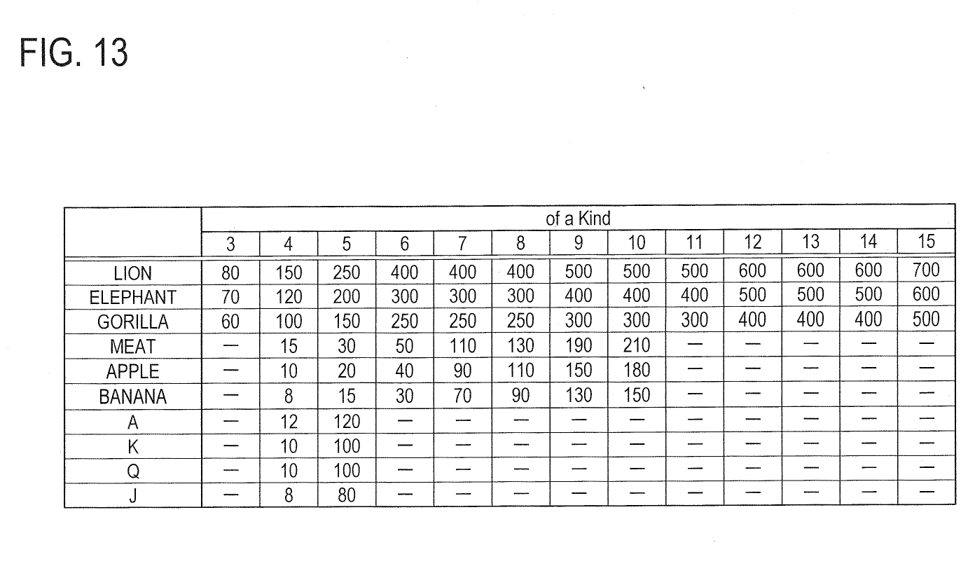

A game executed in the slot machine 1 will be described below. In the game executed in the slot machine 1 according to the embodiment, all the symbols are scatter symbols. More specifically, in the game according to the embodiment, a prize is awarded on the basis of the number of the same types of the symbols displayed on the symbol display areas 111A through 111C, 112A through 112C, 113A through 113C, 114A through 114C, and 115A through 115C arranged in a 3×5 matrix in the variable display portion 3B (refer to FIG. 13).

At the start of the game in the slot machine 1, a player sets a bet amount by operating the BET button. After that, the player depresses the start button. For this reason, a real band starts rotation in each of the reel display portions 101 through 105. That is, in each of the reel display portions 101 through 105, a symbol column drawn on the reel band is scroll-displayed from the upper side to the lower side (refer to FIG. 11).

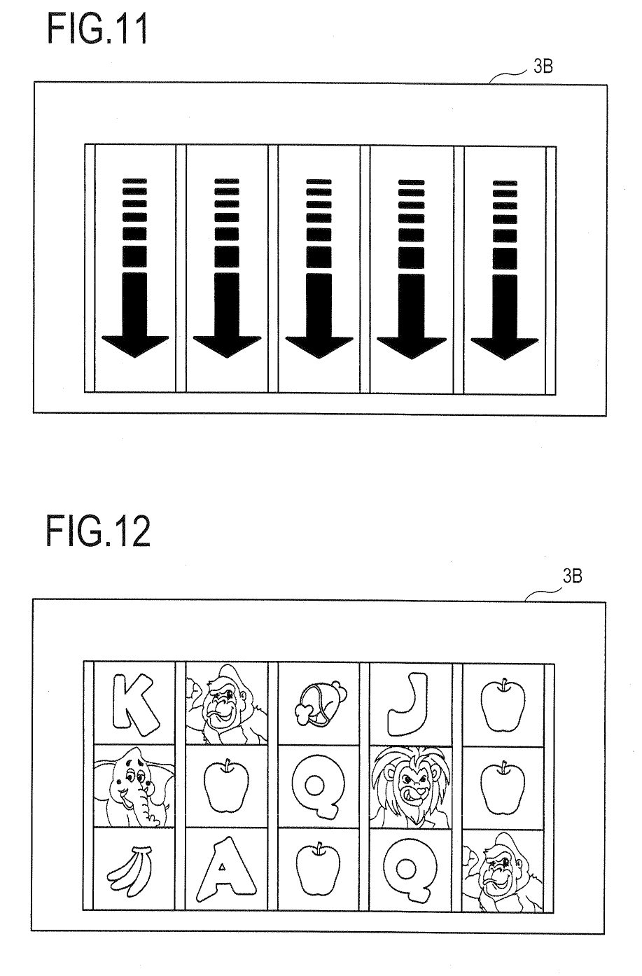

When a predetermined time has elapsed, the reel bands are stopped on the reel display portions 101 through 105. Accordingly, a part of a symbol column configuring each of the reel bands (three symbols configuring each of the reel bands) is stopped on each of the reel display portions 101 through 105. More specifically, as shown in FIG. 12, one symbol is stopped respectively in each of the three symbol display areas constituting each reel display portions. In this manner, the variable display portion 3B stops fifteen symbols (refer to FIG. 12).

As described above, in the game according to the embodiment, a winning combination is determined on the basis of the number of same symbols displayed on the variable display portion 3B. A prize corresponding to the winning combination is awarded to the player. In the winning of the winning combination, the player will be awarded an amount obtained by multiplying a payout amount corresponding to the winning combination by a bet amount (refer to FIG. 13). This point will be described later.

The contents of a winning combination and a prize in the slot machine 1 according to the embodiment will be described below with reference to the accompanying drawings. FIG. 13 is an explanatory diagram showing a payout table in the embodiment.

As shown in FIG. 13, the payout table contains associations between the winning combination and prize to be awarded (i.e., a normal payout amount). In this regard, the normal payout amount of the payout table shown in FIG. 13 is the payout amount when the bet amount is “1”. More specifically, when the bet amount is “1”, the payout amount shown in FIG. 13 is paid out as the normal payout amount. When the bet amount is “2” or more, the amount obtained by multiplying the bet amount by the payout amount shown in FIG. 13 will be paid out as the normal payout amount.

For example, when the five ace symbols 45C are displayed in the fifteen symbol display areas (i.e., symbol display areas 111A through 111C, 112A through 112C, 113A through 113C, 114A through 114C, and 115A through 115C) on the variable display portion 3B, an “amount obtained by multiplying the bet amount by 120 credits” will be paid out to the player (refer to FIG. 13).

When the four jack symbols 45F are displayed in the fifteen symbol display areas on the variable display portion 3B, an “amount obtained by multiplying the bet amount by 8 credits” will be paid out to the player (refer to FIG. 13). Payout amounts are set for each winning combinations in a similar manner, as shown in FIG. 13.

As described above, in the embodiment, when three or more bonus symbols 50 of a specific type of from among mega bonus symbol 51 through the mini bonus symbol 53 (for example, the mega bonus symbols 51) are displayed on the fifteen symbol display areas on the variable display portion 3B, a bonus payout, not a payout amount, is awarded to the player based on the progressive jackpot. The bonus payout to be awarded is determined by the type of the three or more bonus symbols 50 stopped (any one of the mega bonus symbol 51 through the mini bonus symbol 53).

In this regard, when the symbols displayed in the fifteen symbol display areas on the variable display portion 3B do not correspond to any one of the winning combinations shown in FIG. 13, the game is lost. In this case, the normal payout corresponding to the loss is not executed.

The payout table shown in FIG. 13 is a mere example. The types of winning combinations and the contents of prizes can be arbitrarily set. For example, as the contents of the prize, a payout amount can also be arbitrarily set. As the prize in the slot machine 1, the slot machine 1 can be configured to award a bonus game (for example, a free game, an optional bonus game, or the like). Furthermore, the slot machine 1 has a plurality of payout tables, and the slot machine 1 can be configured to make it possible to select a payout table depending on a payout rate.

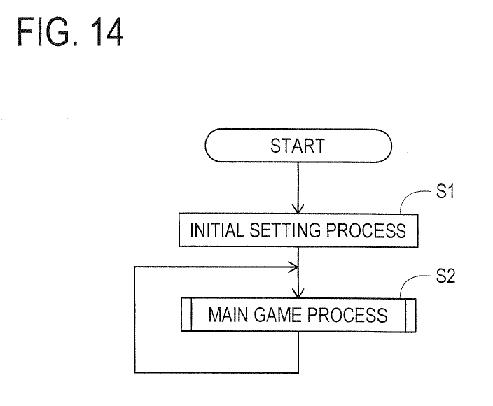

Subsequently, a main control program executed in the slot machine 1 according to the embodiment will be described below in detail with reference to the accompanying drawings. FIG. 14 is a flow chart of a main control program.

First, when the power switch is turned on (upon power on), the main control board 71 and the sub control board 72 are activated. The controller 41 executes an initial setting process (S1). In the initial setting process (S1), the main CPU 42 executes the BIOS stored in the ROM 44, and expands the compressed data incorporated in the BIOS in the RAM 43. Then, the main CPU 42 executes the developed BIOS in the RAM 43. In executing the BIOS that was expanded in the RAM 43, the main CPU 42 carries out a diagnosis and initialization of the different types of peripheral devices. Further, the main CPU 42 writes the game programs and the like from the ROM 44 into the RAM 43. The main CPU 42 acquires payout rate setting data and country identification information. While executing the initial setting process (S1), the main CPU 42 also carries out an authentication process with respect to each program.

When the initial setting process (S1) is terminated, the main CPU 42 executes a main game process (S2). In the main game process (S2), the main CPU 42 sequentially reads out the game programs or the like from the RAM 43 and executes the game programs or the like. By executing the main game process (S2), the game in the slot machine 1 according to the embodiment is executed.

The main game process (S2) is repeatedly executed while electric power is supplied to the slot machine 1.

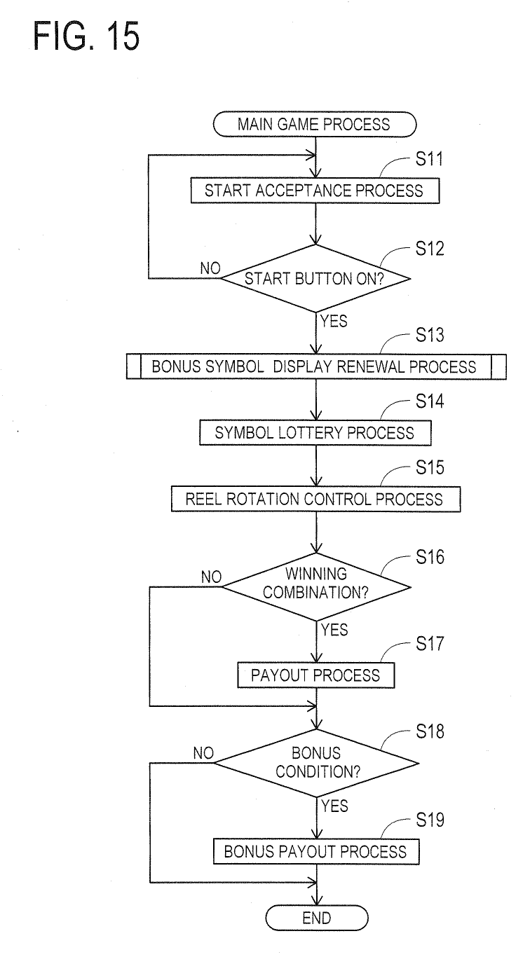

A main game process program executed in the main game process (S2) will be described below with reference to the accompanying drawings. FIG. 15 is a flow chart of a main game process program in the slot machine 1 according the embodiment. Each of the programs shown in the following flowchart is stored in the ROM 44 or the RAM 43 of the slot machine 1, and is executed by the main CPU 42.

As shown in FIG. 15, the main CPU 42 executes a start acceptance process (S11). In the start acceptance process (S11), the player inserts a coin and executes a bet operation using the BET button of the operation buttons 26.

After shifting to S12, the main CPU 42 judges whether the start button of the operation buttons 26 is pressed or not. The main CPU 42 judges the presence/absence of an input to the start button by the presence/absence of a signal based on the depression of the start button. If the start button is pressed (S12: YES), the main CPU 42 subtracts a bet amount set on the basis of the bet operation from a credit amount that the player currently possesses. The main CPU 42 stores the subtraction result in the RAM 43 as bet information. The subtraction of the credit amount and the storing of the bet information are terminated, the main CPU 42 shifts the process to S13. On the other hand, if the start button is not pressed (S12: NO), the main CPU 42 returns the process to the start acceptance process (S11). Accordingly, the player can perform operations, such as correction of the bet amount.

In S13, the main CPU 42 executes a bonus symbol display renewal process. In the bonus symbol display renewal process (S13), the main CPU 42 renews contents of the bonus payout data based on the bet information stored in the RAM 43 in the S12. Then, the main CPU 42 generates the bonus symbols 50 on which the latest bonus content is drawn. The main CPU 42 arranges the generated bonus symbols 50 at predetermined positions on the respective reel bands. The bonus symbol display renewal process (S13) will be described later in detail with reference to the drawings. Therefore, the explanation of the process will be omitted. When the bonus symbol display renewal process (S13) is terminated, the main CPU 42 shifts the process to S14.

In S14, the main CPU 42 executes a symbol lottery process (S14). In the symbol lottery process (S14), the main CPU 42 executes a lottery program stored in the RAM 43 in order to sample a random number value in a numerical value range of a predetermined random number value range. The main CPU 42 determines symbols stopped at the middle portion of the reel display portions (i.e., the symbol display areas 111B, 112B, 113B, 114B, and 115B) based on the sampled random number values and the table.

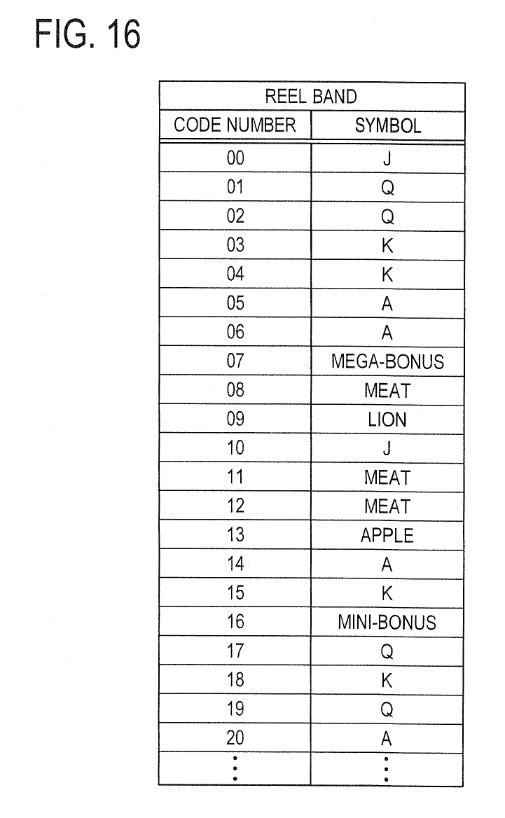

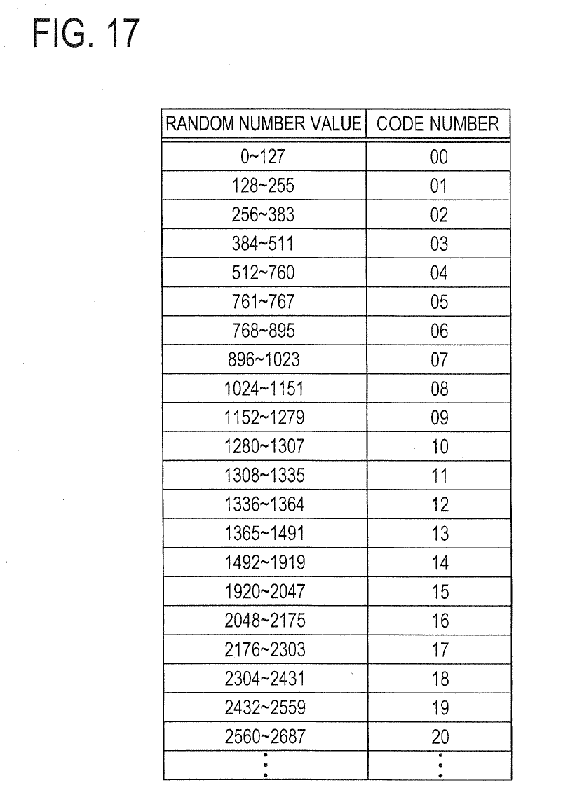

A process using the random number value in the symbol lottery process (S14) will be described below on the basis of the drawings. FIG. 16 shows an example of a table associating symbols drawn on one certain reel band and code numbers. FIG. 17 shows an example of a table associating the random number values and the code numbers.

In this regard, the table associating the symbols and the code numbers (for example, FIG. 16) is exist so as to be associated with the reel display portion 101 through 105.

As described above, in the symbol lottery process (S14), the main CPU 42 executes a lottery program in order to sample a random number value in a predetermined random number range (for example, 0 through 65535). Then, the main CPU 42 determines a code number on the basis of the sampled random number and the table associating the random number values and the code numbers (refer to FIG. 16). When the code number is determined, the main CPU 42 determines symbols to be stopped at the middle portion of the reel display portion on the basis of the code number and the table associating the symbols and the code numbers (refer to FIG. 15).

For example, when the reel band shown in FIG. 15 is used in the reel display portion 101 and a random number value “1136” is sampled, the main CPU 42 determines a code number “08” on the basis of the random number “1136” and the table shown in FIG. 16. The main CPU 42 determines a symbol stopped in the symbol display area 111B on the basis of the code number “08” and the table shown in FIG. 15 as the meat symbol 45B.

The process using the random number value in the symbol lottery process (S14) is not limited to modes using the random number value, the table associating the random number values and the code numbers (for example, refer to FIG. 16), and the table associating the symbols and the code numbers (refer to FIG. 15).

For example, the sampled random number value may be directly associated with the symbols. Further, the sampled random number values may be directly associated with the winning combination, and symbols to be stopped may be determined using the table associating the random numbers and the winning combination.

Referring to FIG. 15 again, a process in executing the main game process program following the symbol lottery process (S14) will be described.

After the symbol lottery process (S14) is terminated, the main CPU 42 executes a reel rotation control process (S15). In the reel rotation control process (S15), the main CPU 42 variably displays reel bands at a predetermined speed on the reel display portions 101 through 105. After that, the main CPU 42 determines an effect pattern of a unit game (pattern of a display of an image on the variable display portion 3B, an audio output from the speaker 34, and the like). The main CPU 42 starts an effect on the basis of the determined effect pattern by controlling the sub control board 72 or the like the unit game means a game that is to be executed by a series of processes until all reel bands are stopped from the time when each of the reel bands begins to be variably displayed.

When a predetermined time has elapsed, the main CPU 42 stops the reel bands on the reel display portions 101 through 105 in a predetermined order. Accordingly, one symbol is stopped in each of the fifteen symbol display areas (i.e., the symbol display areas 111A through 111C, 112A through 112C, 113A through 113C, 114A through 114C, and 115A through 115C) on the variable display portion 3B. With respect to the stop of the reel band on the reel display portion, the symbols on all the reel display portions may be stopped at one time. And, the symbols may be sequentially stopped at different times.

The stop of a symbol will be described in detail with reference to the example of the reel display portion 101 that has been described in the symbol lottery process (S14). According to the above-mentioned specific example, the meat symbol 45B (code number: 8) determined in the symbol lottery process (S14) is stopped in the symbol display area 111B which is a middle portion of the reel display portion 101. In this case, the mega bonus symbol 51 (code number: 7) is displayed in the symbol display area 111A that is an upper portion of the reel display portion 101. The lion symbol 45A (code number: 9) is displayed in the symbol display area 111C that is a lower portion of the reel display portion 101.

As described above, in the bonus symbol display renewal process (S13), the bonus symbol 50 on which the latest bonus payout is drawn is arranged at a predetermined position of each reel band. As a result, in the reel rotation control process (S15), the slot machine 1 can stop the bonus symbol 50 (more specifically, the mega bonus symbol 51 through the mini bonus symbol 53) on which the latest bonus payout is drawn on the variable display portion 3B.

After the reel rotation control process (S15), the main CPU 42 judges whether or not the symbols stopped on the variable display portion 3B correspond to a winning combination (S16). If the winning combination is established (S16: YES), the main CPU 42 calculates a normal payout amount corresponding to the winning combination on the basis of the payout table (refer to FIG. 13). After that, the main CPU 42 shifts the process to S17). On the other hand, if any winning combination is not established (S16: NO), the main CPU 42 shifts the process to S18.

After shifting to S17, the main CPU 42 executes a payout process. In the payout process (S17), the main CPU 42 pays out a normal payout amount depending on the winning combination determined in S16 to a player. When the payout process (S17) is terminated, the main CPU 42 shifts the process to S18.

After shifting to S18, the main CPU 42 judges whether or not one bonus condition from among the three types of the bonus conditions described above is satisfied. More specifically, the main CPU 42 refers to the code numbers of the reel display portions 101 through 105 stored in the RAM 43. The main CPU 42 judges “whether or not the three or more bonus symbols 50 of a specific type (i.e., any one type from among the mega bonus symbol 51 through the mini bonus symbol 53) are stopped in the fifteen symbol display areas of the variable display portion 3B”.

If the bonus condition is satisfied (S18: YES), the main CPU 42 shifts the process to a bonus payout process (S19). On the other hand, if the bonus condition is not satisfied (S18: NO), the main CPU 42 terminates the main game process program. In this case, the main game process program is executed again simultaneously with the termination of the main game process program.

After shifting to S19, the main CPU 42 executes the bonus payout process. In the bonus payout process (S19), the main CPU 42 refers to bonus payout data according to a progressive jackpot satisfying the bonus condition. The main CPU 42 pays out a bonus payout based on the bonus payout data to the player. After the bonus payout is paid out, the main CPU 42 initializes the bonus payout data. More specifically, the main CPU 42 renews the bonus payout data to indicate a regulated initial value. When the bonus payout process (S19) is terminated, the main CPU 42 terminates the main game process program. Also in this case, the main game process program is executed again simultaneously with the termination of the main game process program.

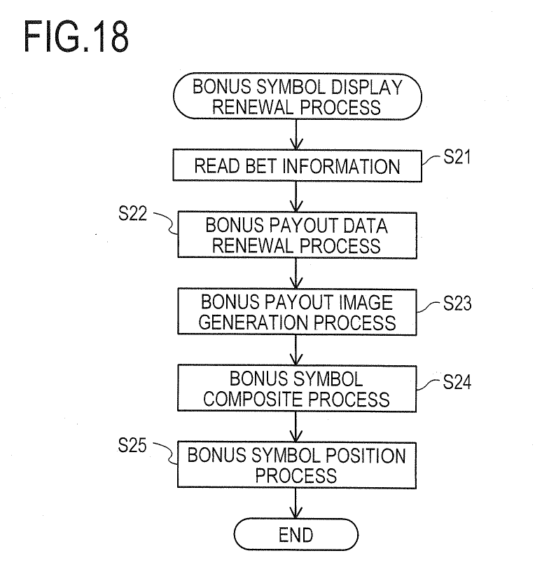

Next, a bonus symbol display renewal process program executed in S13 in the main game process program will be described below in detail with reference to the drawings. FIG. 18 is a flow chart of the bonus symbol display renewal process program.

When the process shifts to S13 to start execution of the bonus symbol display renewal process program, the main CPU 42 reads out the bet information stored by the process in S12 from the RAM 43 (S21). After reading out the bet information, the main CPU 42 shifts the process to S22.

In S22, the main CPU 42 executes the bonus payout data renewal process. In the bonus payout data renewal process (S22), the main CPU 42 accumulates a predetermined percentage of a bet amount shown in the read bet information to each bonus payout data. More specifically, with respect to the mega bonus payout data, the main CPU 42 renews the contents of the mega bonus payout data by accumulating 3% of the bet amount shown in the read bet information. With respect to the major bonus payout data, the main CPU 42 renews the contents of the major bonus payout data by accumulating 2% of the bet amount shown in the read bet information. With respect to the mini bonus payout data, the main CPU 42 renews the contents of the mini bonus payout data by accumulating 1% of the bet amount represented by the read bet information.

After the contents of each of the bonus payout data is renewed into the latest contents on the basis of the bet information, the main CPU 42 shifts the process to S23.

In S23, the main CPU 42 executes a bonus payout image generation process. In the bonus payout image generation process (S23), the main CPU 42 generates the bonus payout images 50C based on the each of bonus payout data renewed into the latest contents.

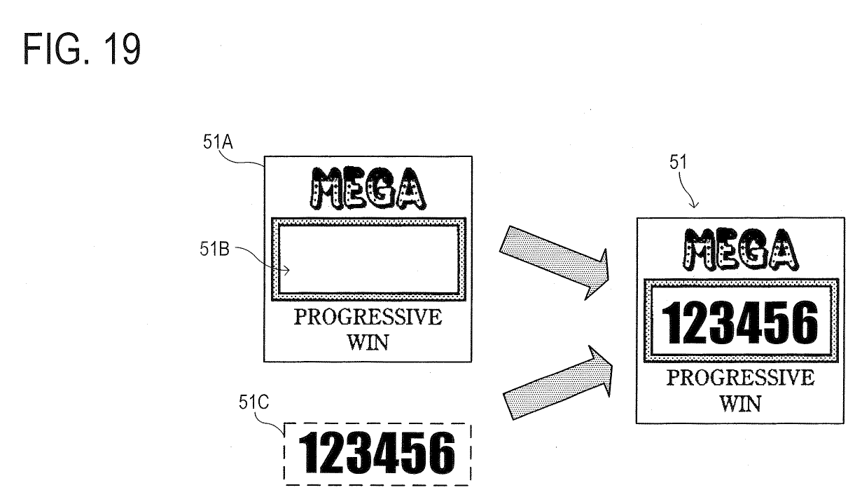

For example, when the mega bonus payout image 51C is generated on the basis of the latest mega bonus payout data, the main CPU 42, first, converts the numerical value of the bonus payout indicated in the mega bonus payout data into digit sequence data (“132456” in the example in FIG. 19). The main CPU 42 transmits the digit sequence data to the image control circuit 81 together with a payout image generation signal. The payout image generation signal or the like is transmitted to the image control circuit 81, so that the main CPU 42 causes the image control circuit 81 to generate the mega bonus payout image 51C on the basis of the digit sequence data related to the bonus payout.

A process of generating the mega bonus payout image 51C in the image control circuit 81 will be concretely described below. Upon receipt of the digit sequence data showing a bonus payout related to “MEGA JACKPOT” and the image payout image generation signal, the image control CPU 82 reads out number image data corresponding to the digit sequence data (number image data of “1”, “2”, “3”, “4”, “5”, and “6” in FIG. 19) from number image data showing numbers “0” through “9” stored in the image ROM 86. After that, the image control CPU 82 generates the mega bonus payout image 51C showing “123456” by arranging the read number image data.

The process of generating the major bonus payout image 52C and the process of generating the mini bonus payout image 53C are the same as the process of generating the mega bonus payout image 51C except that the major bonus payout data and the mini bonus payout data are used. Therefore, explanations about the generation processes of the major bonus payout image 52C and the mini bonus payout image 53C will be omitted.

When the image control circuit 81 which receives the payout image generation signal or the like generates the mega bonus payout image 51C, the major bonus payout image 52C, and the mini bonus payout image 53C, the main CPU 42 terminates the bonus payout image generation process (S23), and shifts the process to S24.

After shifting to S24, the main CPU 42 executes the bonus symbol composite process. In the bonus symbol composite process (S24), the main CPU 42 transmits a bonus symbol generation signal to the image control circuit 81. More specifically, the main CPU 42 causes the image control circuit 81 to generate the bonus symbols 50 on each of which the latest bonus payout is drawn.

The process of the image control circuit 81 in the bonus symbol composite process (S24) will be described below. Upon receipt of the bonus symbol generation signal, the image control CPU 82, first, reads the corresponding bonus symbol base images 50A stored in the image ROM 86. The image control CPU 82 synthesizes the bonus payout images 50C generated in the bonus payout image generation process (S23) in the bonus payout notification area 50B regulated by each bonus symbol base image 50A. In this manner, the image control CPU 82 generates bonus symbols. When the bonus symbol 51 through the mini bonus symbol 53, on each of which the latest bonus payout is drawn, are generated, the main CPU 42 shifts the process to S25.

The process will be concretely described on the basis of the example in S24. First, the image control CPU 82 reads the mega bonus symbol base image 51A from the image ROM 86. As shown in FIG. 19, a mega bonus payout notification area 51B is regulated at a center portion of the mega bonus symbol base image 51A. The image control CPU 82 arranges and synthesizes the mega bonus payout image 51C generated in the bonus payout image generation process (S23) in the mega bonus payout notification area 51B of the mega bonus symbol base image 51A (refer to FIG. 19).

Therefore, the mega bonus payout image 51C showing the latest mega bonus payout is drawn on the mega bonus symbol 51 synthesized as described above. As a result, a player can recognize a bonus payout according to the latest “MEGA JACKPOT” by visually seeking the mega bonus payout image 51C of the mega bonus payout notification area 51B.

When the major bonus symbol 52 is to be generated, the image control CPU 82 synthesizes the major bonus payout image 52C in a major bonus payout notification area 52B of a major bonus symbol base image 52A read from the image ROM 86. When the mini bonus symbol 53 is to be generated, the image control CPU 82 synthesizes the mini bonus payout image 53C in a mini bonus payout notification area 53B of a mini bonus symbol base image 53A read from the image ROM 86.

That is, the process of generating the major bonus symbol 52 and the process of generating the mini bonus symbol 53 are the same as the process of generating the mega bonus symbol 51. Therefore, explanations about the generation processes of the major bonus symbol 52 and the mini bonus symbol 53 will be omitted.

After shifting to S25, the main CPU 42 executes a bonus symbol position process. The bonus symbol position process (S25) is a process which arranges the mega bonus symbol 51 through the mini bonus symbol 53 generated in the bonus symbol composite process (S24) at the positions of the mega bonus symbol 51 through the mini bonus symbol 53 on the reel band related to each of the reel display portion. As described above, each of the latest bonus payout is drawn on the bonus symbols 50 respectively.

More specifically, in the bonus symbol position process (S25), the main CPU 42 transmits a symbol position signal to the image control circuit 81. When the image control CPU 82 receives the symbol position signal, the image control CPU 82 arranges the mega bonus symbol 51 through the mini bonus symbol 53 generated in the bonus symbol composite process at predetermined positions on the reel bands, respectively.

For example, the image control CPU 82 arranges the mega bonus symbol 51 generated in the bonus symbol composite process (S24) at an arrangement position of the mega bonus symbol 51 on the current reel band. In this manner, the mega bonus symbol 51 on the reel band becomes a mega bonus symbol on which a bonus payout related to the latest “MEGA JACKPOT” is drawn. The image control CPU 82 also executes the same process to the major bonus symbol 52 and the mini bonus symbol 53. In this manner, the bonus symbols 50 arranged on the reel band become bonus symbols on each of which the latest bonus payout is drawn.

The image control CPU 82 executes the process to all the reel bands. In this manner, the bonus symbols 50 arranged on all the reel bands used in the slot machine 1 become bonus symbols on each of which the latest bonus payout is drawn. The slot machine 1 variably displays and stops the symbols by using the reel band. Therefore, the bonus symbols 50 on each of which the latest bonus payout is drawn can be stopped on the variable display portion 3B.

After the mega bonus symbol 51 through the mini bonus symbol 53 generated in the bonus symbol composite process (S25) are arranged at the arrangement positions of the mega bonus symbol 51 through the mini bonus symbol 53 on all the reel bands, the main CPU 42 terminates the bonus symbol display renewal process program.

As described above, the slot machine 1 according to the embodiment variably displays and stops the symbols on the reel display portions by using a reel band on which the bonus symbols 50 on each of which the latest bonus payout is drawn are arranged by the bonus symbol display renewal process (S13). Therefore, the slot machine 1 can stop the bonus symbols on each of which the latest bonus payout is drawn on the variable display portion 3B. In this manner, the player can recognize the latest bonus payout by visually seeking the bonus payout stopped on the variable display portion 3B.

Here, the slot machine 1 advances the game by the variable display and the stop of the symbols on the variable display portion 3B. Therefore, the player can visually check the bonus symbols 50 stopped on the variable display portion 3B without largely moving his/her line of sight by vertical movement of his/her neck. As a result, the slot machine 1 can considerably reduce a load on the player when the player recognizes the latest bonus payout.

The slot machine 1 can reduce the movement of the line of sight of the player from the variable display portion 3B on which the game is being executed. Therefore, the slot machine 1 can provide an environment in which the player can concentrate in the game. As a result, the slot machine 1 can enhance an interest in the game.

If a predetermined bonus condition is satisfied (S18: YES), the slot machine 1 awards a bonus payout that is a progressive jackpot (S19) Here, the bonus payout related to the progressive jackpot varies depending on betting of a gaming value by a player or awarding of the bonus payout. In this regard, the slot machine 1 draws the latest bonus payout on the bonus symbols 50 by the bonus symbol display renewal process (S13). Therefore, even though the bonus payout varies, the slot machine 1 can provide information related to an appropriate bonus payout by the respective bonus symbols 50.

The slot machine 1 according to the embodiment has three types of the progressive jackpots (i.e., “MEGA JACKPOT”, “MAJOR JACKPOT”, and “MINI JACKPOT”) as bonus payouts. The bonus symbols 50 (the mega bonus symbol 51 through the mini bonus symbol 53) in plural constitute the bonus conditions under which bonus payouts are awarded based on progressive jackpots. The types of the progressive jackpots are in a one-to-one correspondence with the types of the bonus symbols 50. Furthermore, the latest bonus payouts corresponding to the types of the bonus symbols 50 are drawn on the bonus symbols 50, respectively.

For example, the mega bonus symbol 51 constitutes a bonus condition which the bonus payout related to the “MEGA JACKPOT” is awarded. The latest bonus payout related to “MEGA JACKPOT” is drawn on the mega bonus symbol 51. This relationship is also held between the “MAJOR JACKPOT” and the major bonus symbol 52 and between the “MINI JACKPOT” and the mini bonus symbol 53.

More specifically, the type of the bonus symbol 50 constituting a bonus condition is matched with the latest bonus payout drawn on the bonus symbol 50. Therefore, the slot machine 1 allows a player to clearly and easily recognize a bonus condition and a bonus payout obtained when the bonus condition is satisfied.

The present invention is not limited to the embodiment. Various changes and modifications of the present invention can be made without departing from the spirit and scope of the invention.

For example, the embodiment is configured such that three types of the progressive jackpots (i.e., “MEGA JACKPOT”) can be awarded. However, the present invention is not limited to the configuration. For example, one type of progressive jackpot may be awarded to the player. Furthermore, many types of progressive jackpots may be awarded to the player.

In the embodiment, three types of the bonus symbols 50 (i.e., the mega bonus symbol 51 through the mini bonus symbol 53) are associated with three types of the progressive jackpots, respectively. However, the present invention is not limited to the configuration. For example, one type of the bonus symbol 50 may be associated with three types of the progressive jackpots.

More specifically, progressive jackpots to be awarded to a player may be changed from the three types of the progressive jackpots based on the number of bonus symbols 50 stopped on the variable display portion 3B.

In this case, the three types of bonus payouts related to the progressive jackpots (i.e., “MEGA JACKPOT”, “MAJOR JACKPOT”, and “MINI JACKPOT”) are desirably drawn on one types of the bonus symbols 50, respectively.

The present invention can be realized as a gaming method to execute the processes. Furthermore, the present invention can also be realized as a program which causes a computer to execute the gaming method and a recording medium on which the program is recorded.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display which arranges and displays a plurality of symbols including at least one special symbol on which a progressive payout amount is drawn; and
a processor which executes:
(a) a process of accepting a bet of a gaming value;
(b) a process of extracting image data indicating a progressive payout amount from a memory for illustrating the progressive payout amount on the special symbol after an acceptance of the bet is completed;
(c) a process of over-illustrating the progressive payout amount extracted from the memory on the special symbol and scroll-displaying a symbol column including the plurality of symbols on the display;
(d) a process of repositioning the plurality of symbols on the display by stopping scroll of the symbol column which is scroll-displayed on the display; and
(e) a process of, when a combination of symbols repositioned on the display is a special combination including the special symbol defined for obtaining a progressive payout, paying out the progressive payout amount drawn on the special symbol.

2. A gaming machine comprising:
a display which arranges and displays a plurality of symbols including a special symbol on which a progressive payout amount is drawn; and
a processor which executes:
(a) a process of accepting a bet of a gaming value;
(b) a process of adding a part of a betted gaming value to the progressive payout amount stored in the memory and renewing information indicating the progressive payout amount;
(c) a process of extracting the progressive payout amount renewed from the memory and over-illustrating the progressive payout amount renewed on the special symbol;
(d) a process of scroll-displaying a symbol column including the plurality of symbols on the display;
(e) a process of repositioning the plurality of symbols on the display by stopping scroll of the symbol column which is scroll-displayed on the display; and
(f) a process of, when a combination of symbols repositioned on the display is a special combination including the special symbol defined for obtaining a progressive payout, paying out the progressive payout amount drawn on the special symbol.

3. A gaming machine comprising:
a display which arranges and displays a plurality of symbols including plural types of special symbols on each of which a progressive payout amount is drawn; and
a processor which executes:
(a) a process of accepting a bet of a gaming value;
(b) a process of adding a part of a betted gaming value to each of a plural progressive payout amounts stored in the memory, each corresponding to respective one of the plural types of special symbols, and renewing information indicating each of the plurality of progressive payout amounts;
(c) a process of extracting from the memory each of the plural progressive payout amounts renewed, and drawing a picture of each of the plural progressive payout amounts extracted over respective special symbols corresponding thereto;
(d) a process of scroll-displaying a symbol column including the plurality of symbols on the display;
(e) a process of repositioning the plurality of symbols on the display by stopping scroll of the symbol column which is scroll-displayed on the display; and
(f) a process of, when a combination of symbols repositioned on the display is a special combination including any one of the plural types of special symbols which is defined for obtaining a progressive payout, paying out a progressive payout amount drawn on the one of the plural types of special symbols which is repositioned.
